(19) United States
(12) Patent Application Publication
(10) Pub. No.: US 2024/0386899 A1
(43) Pub. Date: Nov. 21, 2024

(54) DOWNLINK NOISE SUPPRESSION

(71) Applicant: Apple Inc., Cupertino, CA (US)

(72) Inventors: Dersheet C. MEHTA, Chatsworth, CA (US); Hans BERNHARD, Los Angeles, CA (US); Hyunjoung Yang, Los Angeles, CA (US); Jemmy CHEN, Cupertino, CA (US); Phillip J. EASTON, Los Angeles, CA (US)

(21) Appl. No.: 18/444,587

(22) Filed: Feb. 16, 2024

Related U.S. Application Data
(60) Provisional application No. 63/467,001, filed on May 16, 2023.

(51) Int. Cl. G10L 21/0208

(52) U.S. Cl. CPC G10L 21/0208

(57) ABSTRACT

Aspects of the subject technology provide improved techniques for telephony downlink audio processing. Improved techniques include receiving a downlink audio signal, determining whether a noise reduction should be performed for the downlink audio signal, and in response to a determination that the noise reduction should be performed, producing a noise reduced audio signal, and providing the noise reduced audio signal for output via a local loudspeaker.

### CROSS REFERENCED TO RELATED APPLICATION

This application claims the benefit of U.S. Provisional Application No. 63/467,001, entitled “DOWNLINK NOISE SUPPRESSION,” filed May 16, 2023, the entirety of which is incorporated herein by reference.

### TECHNICAL FIELD

The present description relates generally to audio telephony systems, including, for example, downlink noise suppression.

### BACKGROUND

Audio telephony communication systems enable voice conversations between talkers via an electronic communications system. An input transducer captures an uplink audio signal containing speech or speech-like content which is transmitted electronically and then received as a downlink audio signal which can be used as a sink to a loudspeaker or other output transducer. Telephony calls generally include two-way communication, such that each participant in the call can be both a talker and listener with both an uplink audio signal and downlink audio signal for each participant.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an environment in which the subject system may be implemented in accordance with one or more implementations.

FIG. 2 illustrates an example downlink audio processing system according to aspects of the subject technology.

FIG. 3 illustrates an example process for downlink audio processing according to aspects of the subject technology.

FIG. 4 illustrates an example system for audio analysis according to aspects of the subject technology.

FIG. 5 illustrates an example computing device with which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

The subject system may provide for improved telephony techniques including selective noise reduction of a downlink audio signal. As compared to an audio signal captured for telephony uplink, a downlink audio signal often includes several additional sources of noise, such as distortion caused by audio codecs used during transmission between the uplink and downlink. Additionally, there is often little control or knowledge about the audio sources at the downlink receiver-side of a telephony call. Downlink noise suppression effectiveness may be reduced in cases where there are an increased number of noise sources, as well as in cases lacking in control or knowledge of the noise sources at a receiver side of a telephony call. Accordingly, audio noise suppression in telephony is generally applied at the uplink side of a telephony call. Nonetheless, selective noise suppression after downlink may still improve audio quality when properly applied, such as via the subject system.

Implementations of the subject technology may include receiving a downlink audio signal and determining whether a noise reduction should be performed for the downlink audio signal. In response to a determination that the noise reduction should be performed, a noise reduced audio signal may be produced, and the noise reduced audio signal may be provided for output via a local telephony participant. In an aspect, the received downlink audio signal may have been initially generated at a microphone (or other acoustic input transducer) of a source device as an uplink audio signal and then transmitted to a receiver device via a network as a downlink audio signal during a telephony call between the source device and the receiver device. A telephony call may include a call between cellphone or telephones. In other examples, a telephony call may by a video conference and include an associated video signal, or a telephony call may be a multi-user gaming session with live communication of a voice conversation between gameplayers.

In some optional aspects a determination that downlink noise reduction should be performed may be based on one or more switches that control the downlink noise reduction. For example, the switches may include a user control switch at the downlink, such as physical switch or software user interface configured for a listener user at the local loudspeaker to disable or enable the noise reduction. In another examples, the switches may include a software switch configured to automatically disable or enable the noise reduction without intervention by the listener at the local loudspeaker, or user control of the noise reduction may be combined with automated software control of the noise reduction. An automated software switch may include preprocessing of the downlink audio signal to determine whether downlink noise reduction should be performed. In response to a determination that the noise reduction should not be performed, some implementations may forego the performing of the noise reduction on the downlink audio signal, and may provide the received downlink audio signal without the noise reduction for output via a local acoustic output transducer.

FIG. 1 illustrates an environment 100 in which the subject system may be implemented in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

Environment 100 includes two user devices 112, 114 engaged in a telephony call via network 110. Device 114 may be located at a first location of user 104, and device 114 may include microphone 108 configured for sensing speech from user 104 as a source of an audio signal. Device 112 may be located at a second location of user 102, and device 112 may be include loudspeaker 106 configured for emitting a downlink signal audible to user 102. An uplink audio signal may be audio captured by microphone 108 at the first location for user 104 and sent to network 110, and a downlink audio signal may be received by device 112 from network 110 at the second location for user 102.

In as aspect, device 112 and/or device 114 may be, for example, a cellphone or wired telephone. As depicted in FIG. 1, microphone 108 and loudspeaker 106 may be included in their respective devices 112, 114. In other embodiments (not depicted) microphone 108 and/or loudspeaker 106 may be physically separate and located, for example, in a headset or earbud that is associated with the respective device 112, 114.

In an aspect for two-way telephony (not depicted), devices 112 and 114 each may both provide an uplink audio source and act as a downlink audio receiver. In another aspect (also not depicted), network 110 may include intermediary devices between users 102 and 104 such a computer server or network relay. Uplink audio from both devices 112, 114 may be uploaded to intermediary devices and then downloaded from intermediary devices and received as downlink audio by both devices 112, 114.

Example noise sources in downlink audio received by device 112 include environmental noise in the environment of a remote device (e.g. noises around device 114 and user 104 when the source audio signal is sensed by microphone 108), circuitry noise of a remote acoustic input transducer (such as microphone 108) used to create a source electronic audio signal, audio signal processing artifacts at the location of user 104, audio signal encoding such as compression with an audio or speech codec, network artifacts such delayed delivery, out-of-order delivery, corruption, or complete loss of network packets containing the encoded audio, and decoding of encoded audio.

Other example environments not depicted in FIG. 1 in which the subject system may be implemented in accordance with one or more implementations may include downlink simplex or half-duplex voice communications. For example, talker on a telephony device may leave a voicemail recording for another user. Such a voicemail recording may include many of the noise sources above, such as a noisy environment, input transducer artifacts, and voice codec artifacts. In another example environment, downlink audio and then used without output to a loudspeaker. For example, downlink audio may be output to a speech-to-text processor for a telephony participant in a noisy environment or with hearing loss.

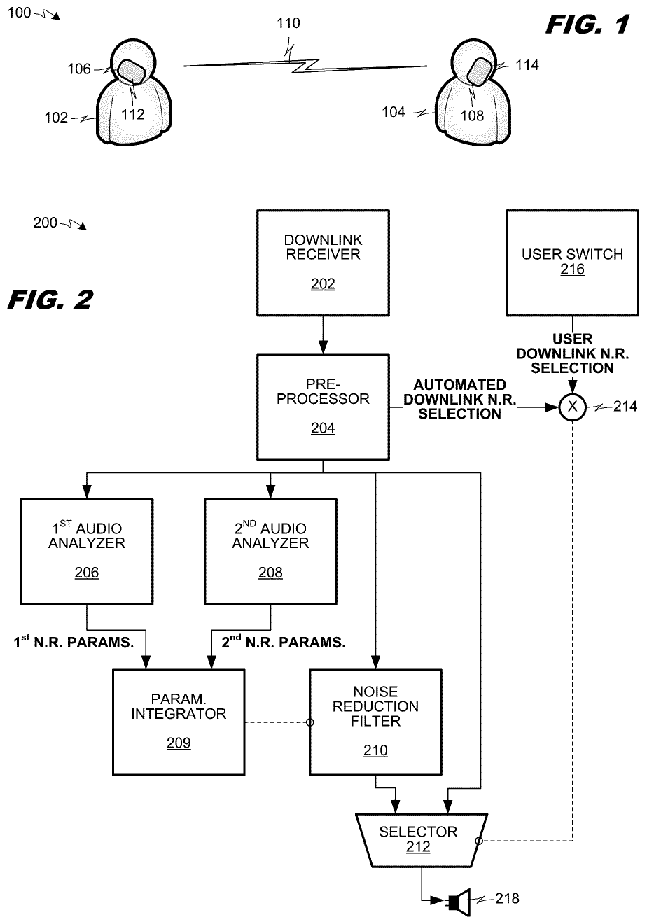

FIG. 2 illustrates an example downlink audio processing system 200 according to aspects of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

System 200 may be implemented, for example, by device 112 (FIG. 1). System 200 include a downlink receiver 202, preprocessor 204, first audio analyzer 206, second audio analyzer 208, noise reduction parameter integrator 209, noise reduction filter 210, selector 212, control switch 214, user switch 216, and local loudspeaker 218. In operation, a downlink audio signal may be received from an uplink audio source and via a network at downlink receiver 202. Preprocessor 204 may perform preliminary processing of the received downlink audio signal, such as decoding when the downlink signal is encoded, and/or performing a frequency analysis and converting the downlink signal into a frequency representation.

First and second audio analyzers 206, 208 may perform additional audio processing to the downlink audio signal output from preprocessor 204 and produce first noise reduction and second noise reduction parameters, respectively. The first and second noise reduction parameters may be integrated by parameter integrator 209 into a hybrid noise reduction control that may be applied at noise reduction filter 210.

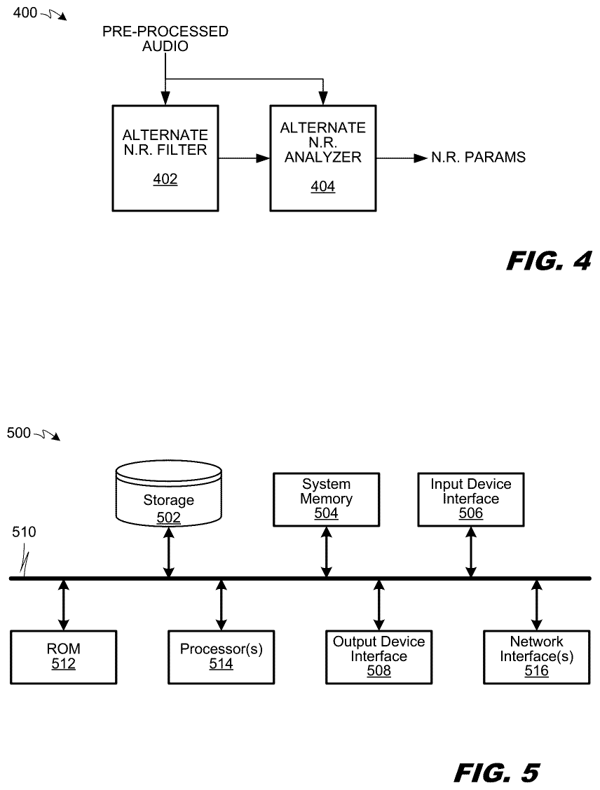

In one example, first audio analyzer 206 may analyze the frequency representation from preprocessor 204 and generate first noise reduction control parameters that could be used by noise reduction filter 210 to reduce noise in the downlink audio signal. For example, first audio analyzer 206 may identify which frequency bands in the downlink audio signal contain noise and/or a talker's voice, and may generate first noise reduction control parameters indicating a gain control for different frequency bands of the downlink audio signal. In this example, second audio analyzer 208 may produce second noise reduction parameters that also indicate frequency banks that likely contain mostly a talker voice and which frequency bands likely contain mostly noise. In an aspect, the first and second audio analyzers 206, 208 may produce their respective first and second noise reduction parameters via different techniques. For example, first audio analyzer may use a machine learning model trained to characterize frequency bands, while second audio analyzer may use an alternate noisy modeling system. Second audio analyzer may not use a machine learning model and may be based, for example, on a preexisting legacy noise reduction technique. An example audio analyzer based on an alternate noise reduction filter is described below regarding FIG. 4.

Noise reduction parameter integrator 209 may combine first and second noise reduction parameters from the first and second audio analyzers 206, 208 to produce hybrid noise control parameters. For example, parameter integrator 209 may modify the first noise reduction parameters based on the second noise reduction parameters, or vise versa. The resulting hybrid noise reduction parameters may be used to control noise reduction filter 210.

Noise reduction filter 210 may then, based on the noise reduction control parameters, apply a lower gain (e.g., reduce volume or signal energy) to frequency bands containing more noise or less voice, and may apply a comparatively higher gain to frequency bands containing less noise or more voice.

In an aspect, audio analyzer 206 may include a machine learning model for generating noise reduction parameters. For example, a first machine learning model may accept a frequency response representation of a downlink audio signal from preprocessor 204 as input, and the machine learning model may produce noise reduction parameters as output. Such a machine learning model may be trained with various combinations of different human voices and different noise sources to be able to determine which frequency bands in a downlink audio signal contain primarily noise and which frequency bands contain primarily a human voice.

Preprocessor 204 may also analyze the downlink audio signal and generate an automated downlink noise reduction (N.R.) selection for enabling or disabling downlink noise reduction. In an aspect, preprocessor 204 may estimate a noise level or otherwise characterize noise in the received downlink audio, and an automated noise reduction selection control may be generated based on the noise level or other estimated noise characteristic. For example, the automated noise selection control may indicate that downlink noise reduction should be applied when the estimated noise level is above a threshold, and that downlink noise reduction should be foregone when the estimated noise level is below the threshold. In another example, preprocessor 204 may include a machine learning model that generates an automated downlink noise reduction selection. For example, a second machine learning model may accept a downlink audio signal as input and may generate an output indicating that downlink audio noise reduction may be effective or not as the automated downlink noise reduction selection.

In addition to, or instead of, the automated downlink noise reduction selection, a user at the downlink location may provide a downlink noise reduction selection. For example, a listener of the downlink audio may find the audio emitted by a loudspeaker to include objectionable audio artifacts or may find the talker to be unintelligible and the listener may attempt to toggle the user downlink noise reduction selection. This may enable the user may discover whether the user's downlink audio preference includes or does not include downlink audio reduction.

Selector 212 may select between either the noise reduced audio from noise reduction filter 210 or a version of the downlink audio signal without noise reduction for output to a local loudspeaker 218 (or other audio output transducer). Selector 212 may select between the downlink signal with or without noise reduction based on an automated downlink noise reduction selection (e.g., generated by preprocessor 204) and/or a user downlink noise reduction selection (e.g., generated by a user switch 216). In an aspect, user switch may include a physical switch and/or may include software user interface setting. A physical switch may allow a user to quickly enable or disable downlink noise reduction in the middle of a telephony call.

Control switch 214 may combine user and automated downlink noise reduction selections. For example, selections may be combined by allowing the user selection to override the automated selection. In another example, the selections may be combined based on a confidence level associated with the automated selection. In this example, a user switch may indicate a general preference from the user which may be overridden when a conflicting automated downlink selection is associated with a high level of confidence.

In an aspect, loudspeaker 218 may be part of system 200 as depicted in FIG. 2, or may be physically located in a separate device, such as a headset or earbud, that is associated with system 200. In other implementations, an output transducer may not be included at all, for example where the output of selector 212 may be provided to a speech-to-text processor for telephony participant that cannot hear a loudspeaker output (for example, due to deafness or because the telephony participant is in a noisy environment).

In other aspects, downlink receiver 202 is optional and may not be included in some implementations. For example, a downlink receiver in another device may record downlink audio in a voicemail. Then the other components of system 200 may be used to apply noise reduction to the downlink audio recorded in the voicemail.

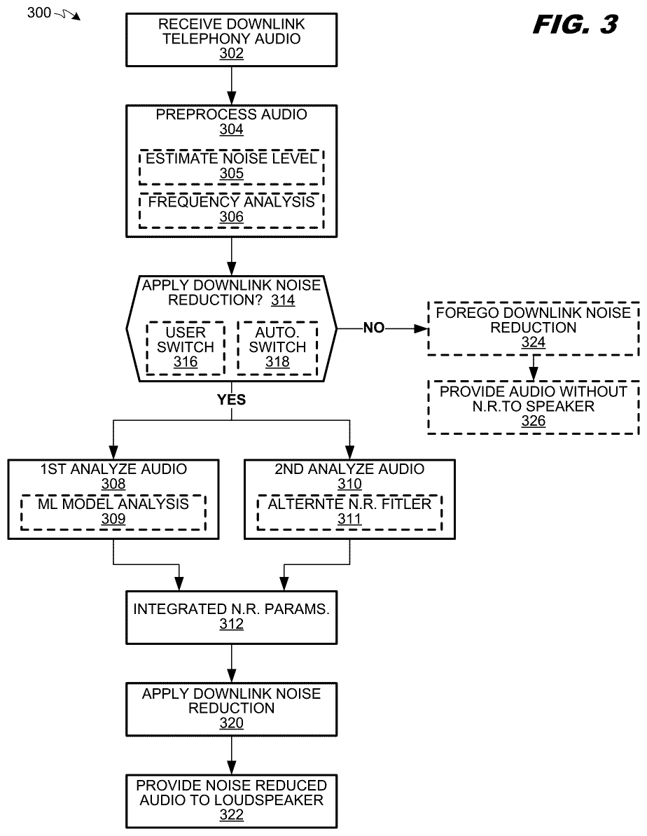

FIG. 3 illustrates an example process 300 for downlink audio processing according to aspects of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

Process 300 may be performed by, for example, a downlink audio receiver such device 112 (FIG. 1), and may be performed by system 200 (FIG. 2). Process 300 includes receiving downlink audio (302), such as at downlink receiver 202 or as a voicemail recording, pre-processing the downline audio (304), such as by pre-processor 204, and determining whether downlink noise reduction should be applied (314), such as at control switch 214. The downlink audio may be first analyzed (308) and second analyzed (310) to produce respective first and second noise reduction parameters, such as by first and second analyzers 206, 208. The first and second noise reduction parameters may be integrated (312), such as by parameter integrator 209, to produce hybrid noise reduction parameters. The hybrid noise reduction parameters may then be used to apply a downlink noise reduction (320) to produce a noise reduced version of the downlink audio signal, such as at noise reduction filter 210. The noise reduced downlink audio signal may be provided to a loudspeaker (322), such as local loudspeaker 218.

In an aspect, downlink audio may be received at a local device, such as device 112, during a telephony call from a remote device, such as device 114. For example, the remote device may include a microphone for recording a user talker at a remote location as a source of an uplink audio signal. In other aspect, when the downlink noise reduction is not to be applied (314), downlink noise reduce may be foregone or not performed, and a downlink audio signal without noise reduction may be provided to the loudspeaker.

The received downlink audio may be preprocessed (304), such as by preprocessor 204. In an aspect, the preprocessing (304) may include estimating a noise level (305) in the received downlink audio, and an automated switch (318) for determining whether to apply downlink noise reduction (314) may be based on the estimated noise level. In another aspect, preprocessing (304) may include a frequency analysis (306), such as by preprocessor 204. The frequency analysis (306) may include, for example, a discrete cosine transform or a discrete Fourier transform, and may produce a frequency domain representation of the downlink audio signal. In an aspect, first and second analyzing of audio (308, 310) may be performed on the frequency domain representation of the downlink audio signal to produce corresponding first and second noise reduction control parameters. In an aspect, first analysis of audio (308) may include analysis by a machine learning model (309), while second analysis of audio (310) may include an alternate noise reduction filter (311). The first and second noise reduction parameters may be integrated (312), for example by averaging corresponding parameters into hybrid noise reduction parameters, and the hybrid noise reduction parameters may be applied to the downlink audio signal (320).

In aspects, a determination to apply downlink noise reduction (314), may be based on a user switch (316) and/or an automated switch (318). A user switch, such as user switch 216, may include a physical switch and/or a software user interface switch. An automated switch may be controlled by preprocessing, such as by preprocessor 204. When a determination is made to not apply downlink noise reduction (314), the downlink noise reduction may be foregone (314), and the downlink audio signal without noise reduction may be provided to a loudspeaker, such as local loudspeaker 218.

FIG. 4 illustrates an example audio analyzer 400 according to aspects of the subject technology. Analyzer 400 may be an example implementation of first or second audio analyzers 206, 208 (FIG. 2). Analyzer 400 includes an alternate noise reduction filter 402, and alternate noise reduction analyzer 404. In operation, pre-processed audio (for example from pre-processor 204), may be input to alternate noise reduction filter 402, which may apply noise reduction techniques and provide an audio signal with reduced noise to alternate noise reduction analyzer 404. The alternate noise reduction techniques may be, for example, a pre-existing legacy noise reduction technique which may operate well for some noise sources, but may not operate as well on other noise sources. Noise reduction analyzer 404 may compare the reduced noise output from the alternate technique to the pre-processed audio input in order to estimate noise reduction parameters that were applied by alternate techniques of filter 402. For example, noise reduction analyzer 404 may compare a magnitude or envelope within frequency bands of the pre-processed input to a magnitude or envelope within frequency bands of the noise reduced result in order to estimate a gain applied by the alternate techniques to the different frequency bands. Analyzer 404 may then output noise reduction parameters indicating various gains to be applied to corresponding frequency bands.

FIG. 5 illustrates an example computing device 500 with which aspects of the subject technology may be implemented in accordance with one or more implementations, including, for example system 200 (FIG. 2) and process 300 (FIG. 3). The computing device 500 can be, and/or can be a part of, any computing device or server for generating the features and processes described above, including but not limited to a laptop computer, a smartphone, a tablet device, a wearable device such as a goggles or glasses, an earbud or other audio device, a case for an audio device, and the like. The computing device 500 may include various types of computer readable media and interfaces for various other types of computer readable media. The computing device 500 includes a permanent storage device 502, a system memory 504 (and/or buffer), an input device interface 506, an output device interface 508, a bus 510, a ROM 512, one or more processing unit(s) 514, one or more network interface(s) 516, and/or subsets and variations thereof.

The bus 510 collectively represents all system, peripheral, and chipset buses that communicatively connect the numerous internal devices of the computing device 500. In one or more implementations, the bus 510 communicatively connects the one or more processing unit(s) 514 with the ROM 512, the system memory 504, and the permanent storage device 502. From these various memory units, the one or more processing unit(s) 514 retrieves instructions to execute and data to process in order to execute the processes of the subject disclosure. The one or more processing unit(s) 514 can be a single processor or a multi-core processor in different implementations.

The ROM 512 stores static data and instructions that are needed by the one or more processing unit(s) 514 and other modules of the computing device 500. The permanent storage device 502, on the other hand, may be a read-and-write memory device. The permanent storage device 502 may be a non-volatile memory unit that stores instructions and data even when the computing device 500 is off. In one or more implementations, a mass-storage device (such as a magnetic or optical disk and its corresponding disk drive) may be used as the permanent storage device 502.

In one or more implementations, a removable storage device (such as a floppy disk, flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random-access memory. The system memory 504 may store any of the instructions and data that one or more processing unit(s) 514 may need at runtime. In one or more implementations, the processes of the subject disclosure are stored in the system memory 504, the permanent storage device 502, and/or the ROM 512. From these various memory units, the one or more processing unit(s) 514 retrieves instructions to execute and data to process in order to execute the processes of one or more implementations.

The bus 510 also connects to the input and output device interfaces 506 and 508. The input device interface 506 enables a user to communicate information and select commands to the computing device 500. Input devices that may be used with the input device interface 506 may include, for example, alphanumeric keyboards and pointing devices (also called “cursor control devices”). The output device interface 508 may enable, for example, the display of images generated by computing device 500. Output devices that may be used with the output device interface 508 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 510 also couples the computing device 500 to one or more networks and/or to one or more network nodes through the one or more network interface(s) 516. In this manner, the computing device 500 can be a part of a network of computers (such as a LAN, a wide area network (“WAN”), or an Intranet, or a network of networks, such as the Internet. Any or all components of the computing device 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, pseudo-static RAM (PSRAM), SPIRAM, TCM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks may or may not be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components (e.g., computer program products) and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving a downlink audio signal;
determining whether a noise reduction should be performed for the downlink audio signal; and
in response to a determination that the noise reduction should be performed, performing the noise reduction on the downlink audio signal to produce a noise reduced audio signal, and providing the noise reduced audio signal for output via a local loudspeaker.

2. The method of claim 1, wherein the downlink audio signal is generated at a microphone of another device and is received during a telephony call from the other device via a network.

3. The method of claim 1, wherein:
the determining that the noise reduction should be performed is based on one or more switches controlling downlink noise reduction; and
the one or more switches includes a physical switch configured for a listener at the local loudspeaker to disable or enable the noise reduction.

4. The method of claim 1, wherein:
the determining that the noise reduction should be performed is based on one or more switches controlling downlink noise reduction including a software switch configured to disable or enable the noise reduction, and the software switch based on a preprocessing of the downlink audio signal.

5. The method of claim 1, further comprising:
in response to a determination that the noise reduction should not be performed, foregoing the performing of the noise reduction on the downlink audio signal, and providing the received downlink audio signal without the noise reduction for output via a local loudspeaker.

6. The method of claim 1, wherein applying the noise reduction comprises:
first analyzing the downlink audio signal with machine learning model to produce first noise reduction parameters;
second analyzing the downlink audio signal with an alternate noise reduction filter to produce second noise reduction parameters;
integrating first and second noise reduction parameters to produce third noise reduction parameters performing the noise reduction on the downlink audio signal based on the third noise reduction parameters to produce the noise reduced audio signal.

7. The method of claim 1, wherein applying the noise reduction further comprises:
post-processing the noise reduced audio signal before output via the local loudspeaker.

8. A device, comprising:
a memory; and
at least one processor configured to:
receive a downlink audio signal;
determine whether a noise reduction should be performed for the downlink audio signal; and
in response to a determination that the noise reduction should be performed, perform the noise reduction on the downlink audio signal to produce a noise reduced audio signal, and provide the noise reduced audio signal for output via a local loudspeaker.

9. The device of claim 8, wherein the device is a phone or headphone, and further comprises a receiver configured to receive an audio signal from a downlink in a telephony call.

10. The device of claim 8, wherein the downlink audio signal is generated at a microphone of another device and is received during a telephony call from the other device via a network.

11. The device of claim 8, wherein:
the determination that the noise reduction should be performed is based on one or more switches controlling downlink noise reduction; and
the one or more switches includes a physical switch configured for a listener at the local loudspeaker to disable or enable the noise reduction.

12. The device of claim 8, wherein:
the determination that the noise reduction should be performed is based on one or more switches controlling downlink noise reduction including a software switch configured to disable or enable the noise reduction, and the software switch based on a preprocessing of the downlink audio signal.

13. The device of claim 8, wherein the processor is further configured to:
in response to a determination that the noise reduction should not be performed, foregoing the performing of the noise reduction on the downlink audio signal, and providing the received downlink audio signal without the noise reduction for output via a local loudspeaker.

14. The device of claim 8, wherein applying the noise reduction comprises:
first analyzing the downlink audio signal with machine learning model to produce first noise reduction parameters;
second analyzing the downlink audio signal with an alternate noise reduction filter to produce second noise reduction parameters;
integrating first and second noise reduction parameters to produce third noise reduction parameters performing the noise reduction on the downlink audio signal based on the third noise reduction parameters to produce the noise reduced audio signal.

15. The device of claim 8, wherein applying the noise reduction further comprises:
post-processing the noise reduced audio signal before output via the local loudspeaker.

16. A non-transitory computer readable memory storing instructions that, when executed by a processor, cause the processor to:
receiving a downlink audio signal;
determining whether a noise reduction should be performed for the downlink audio signal; and
in response to a determination that the noise reduction should be performed, performing the noise reduction on the downlink audio signal to produce a noise reduced audio signal, and providing the noise reduced audio signal for output via a local loudspeaker.

17. The computer readable memory of claim 16, wherein the downlink audio signal is generated at a microphone of another device and is received during a telephony call from the other device via a network.

18. The computer readable memory of claim 16, wherein:
the determination that the noise reduction should be performed is based on one or more switches controlling downlink noise reduction; and
the one or more switches includes a physical switch configured for a listener at the local loudspeaker to disable or enable the noise reduction.

19. The computer readable memory of claim 16, wherein:
the determination that the noise reduction should be performed is based on one or more switches controlling downlink noise reduction including a software switch configured to disable or enable the noise reduction, and the software switch based on a preprocessing of the downlink audio signal.

20. The computer readable memory of claim 16, further comprising:
in response to a determination that the noise reduction should not be performed, foregoing the performing of the noise reduction on the downlink audio signal, and providing the received downlink audio signal without the noise reduction for output via a local loudspeaker.
